(19) United States
(12) Patent Application Publication
(10) Pub. No.: US 2003/0235806 A1
(43) Pub. Date: Dec. 25, 2003

(54) Conversation practice system with dynamically adjustable play speed and the method thereof

(76) Inventors: Say Ling Wen, Taipei (TW); Zechary Chang, Taipei (TW); Pinky Ma, Beijing (CN)

Correspondence Address: JACOBSON HOLMAN PLLC, 400 SEVENTH STREET N.W., SUITE 600, WASHINGTON, DC, 20004, US

(21) Appl. No.: 10/173,620

(22) Filed: Jun. 19, 2002

(51) Int. Cl. G09B 19/00

(52) U.S. Cl. 434/156

(57) ABSTRACT

A conversation practice system with a dynamically adjustable play speed and the method thereof are disclosed. A user can perform dynamical parameter settings at any time during the learning process through a UI. The system immediately updates according to the settings to create a reading environment satisfying the user's needs. The system contains: a material database, a problem-making module, a follow-reading practice module, and a dynamical parameter setting module. The method includes the steps of: starting the conversation practice system and performing initialization of parameter settings, obtaining material sample data and beginning the follow-reading practice process, the user's dynamical parameter settings during the follow-reading process, re-starting the follow-reading practice process according to the dynamical parameter setting contents, and completing the whole follow-reading practice process by the user.

### BACKGROUND OF THE INVENTION

1. Field of Invention

The invention relates to a computer-aided language learning system and the method thereof. In particular, the invention pertains to a conversation practice system and method that allow its user to dynamically set parameters during the follow-reading process and immediately make adjustments.

2. Related Art

As the world is turning into a global village so that people from every corner of the world have more communications, learning foreign languages has become a rudimentary need. Since it is very important to let other people understand what you want to express using a foreign language at the same time to understand what other people are speaking about, enhancing the listening and speaking abilities have been important objectives in current foreign language teaching and learning.

In the respect of listening, it is of consequence for a learner to be able to understand the meaning immediately after hearing a sentence. That is, the learner has to be able to catch each word in the sentence and then comprehend its meaning. Therefore, it is of great benefit to listen to people speaking the foreign language, thereby getting familiar with the tone, speed, and ascent.

In the respect of speaking, how to speak fluently, correctly and accurately so that other people can understand what the learner is talking about is the objective. To achieve the above-mentioned goal, the learner needs to practice his or her pronunciation by immitation. Only via continuously immitating the tone, speed, and ascent of a native speaker can indeed improve the learner's speaking ability.

Since people communicate through voices, listening comprehension is a very important part of foreign language training. If the foreign language practice speed during the training process is beyond the acceptable limit, the learner may encounter great difficulty in recognizing and comprehending conversations. This may result in deep frustration for the learner because he or she cannot understand certain voice characters in the conversation content. As the listening training is not solid, the learner's speaking ability will be affected too. Therefore, the listening comprehension part is essential.

### SUMMARY OF THE INVENTION

In view of the foregoing, the invention provides a conversation practice system with a dynamically adjustable play speed and the method thereof. A primary objective of the invention is to allow a user to dynamically setting parameters during a follow-reading process and immedaitely make adjustments. The user is thus able to accustom himself or herself to the conversation environment provided by the invention.

To achieve the above objective, the conversation practice system with a dynamically adjustable play speed of the invention includes: a material database, a problem module, a follow-reading module, and a dynamical parameter-setting module.

Furthermore, the disclosed conversation practice method with a dynamically adjustable play speed includes the following steps. The first step starts a conversation practice system and performs parameter-setting initialization. Afterwards, sample problem data are retrieved and a follow-reading procedure is started. A user then performs dynamical parameter settings during the follow-reading procedure. The follow-reading procedure is adjusted according to the dynamical parameter settings. Finally, the user completes the whole follow-reading procedure.

### BRIEF DESCRIPTION OF THE DRAWINGS

The invention will become more fully understood from the detailed description given hereinbelow illustration only, and thus are not limitative of the present invention, and wherein:

FIG. 1 shows the system structure of the disclosed conversation practice system with a dynamically adjustable play speed and the method thereof;

FIG. 2 shows the operation procedure of the invention;

FIG. 3 shows the dynamical parameter adjusting flowchart of the invention; and

FIG. 4 shows an embodiment of the invention.

### DETAILED DESCRIPTION OF THE INVENTION

This specification discloses a conversation practice system with a dynamically adjustable play speed and the method thereof. A UI (User Interface) 100 is provided to allow a user to perform play speed-related parameter settings during a follow-reading procedure. A conversation practice system 200 immidiately adjusts itself to give a personally customized learning environment, thereby increasing the learner's learning effects.

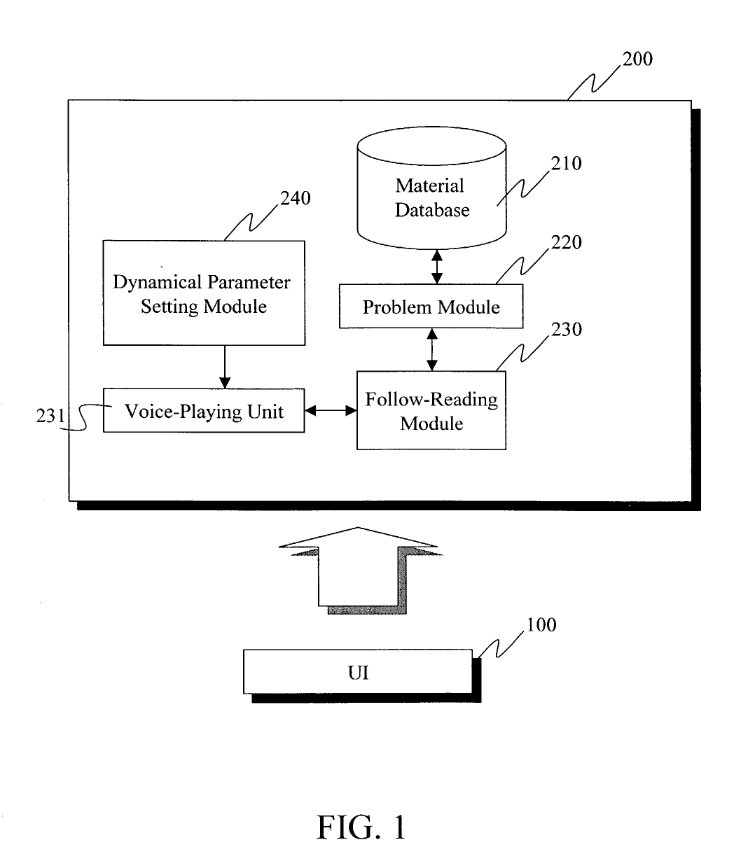

We use FIG. 1 to explain the system structure of the invention:

A material database 210 is used to store all sample problem data. Each sample problem datum contains a material sample datum code (for a problem module 220 to extract), a standard demonstrative voice content, and a material sample picture and text content (including texts, videos, picture, etc). The database is mainly used to provide problems for the user to practice reading.

A problem module 220 is used to select and extract correct problem sample data from the material database 210. The problem module 220 composes problems according to the subjects set in the conversation practice system 200 or the user's level. A number may be randomly generated for composing problems from the material sample data.

A follow-reading module 230 is used to output the problem sample data extracted by the problem module 220 to the user for follow-reading. A voice-playing unit 231 in the follow-reading module 230 is employed for output. All the output is executed according to the parameter setting content of the conversation practice system 200.

A dynamical parameter-setting module 240 is provided for the user to set parameters relevant to the play speed in the follow-reading process. The setting results are immediately reflected on the voice-playing unit 231 of the follow-reading module 230. Therefore, the user can dynamically change the play speed settings during the follow-reading process, ensuring a satisfactory learning environment.

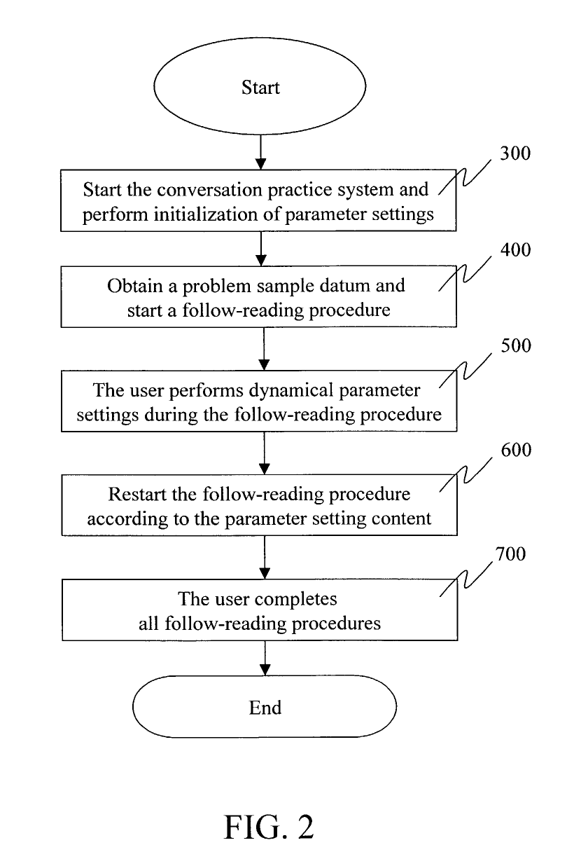

We use FIG. 2 to explain the main procedure of the disclosed conversation practice system 200. First, the conversation practice system 200 of the invention is started. The system automatically performs initialization of parameter settings (step 300). That is, the system uses predetermined parameters to initialize each module. When the user starts to do conversation practices, the system randomly extracts a problem sample from a material database 210 in accordance with predetermined subject settings and the user's ability. This problem sample datum is used for the user to start the follow-reading process (step 400). During the process, the user can dynamically perform parameter settings through a UI (User Interface) 100 at any time (step 500). After the user completes all parameter settings, the conversation system 200 immediately adjusts the predetermined setting values and then uses the new setting values on the follow-reading process (step 600). Finally, the user completes the whole follow-reading process in the personalized environment and the procedure finishes (step 700).

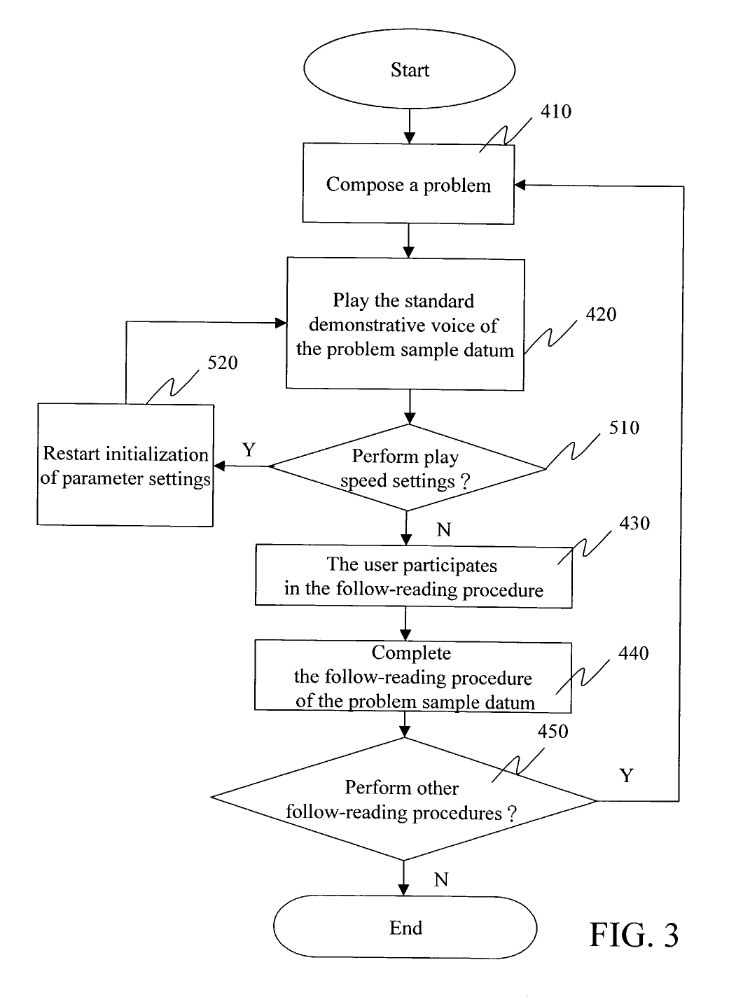

In fact, the invention is featured in the dynamical setting adjustment. Therefore, we use FIG. 3 for a further explanation. When the conversation practice system 200 starts to compose problems (step 410), the standard demonstrative voice extracted from the material sample data is first played (step 420). The play settings at this moment are still the default ones set by the system. After playing the standard demonstrative voice, the system determines whether the user makes any modification to the play settings through the UI 100 (step 510). If there is any changes, the system immediately modifies the setting parameters according to the user's operation on the voice-playing unit 231. After the new parameters are entered, the system returns to step 420 and plays the standard demonstrative voice again. If the user does not make any changes, the system simply continues to the subsequent follow-reading procedure, completing the problem sample data and the whole follow-reading procedure (step 440). Of course, each time the follow-reading procedure for a problem sample is completed, the user can decide whether to go on to other problems and the associated follow-reading procedure (step 450). If the user wants to continue, then the system returns to step 410; otherwise, the procedure finishes.

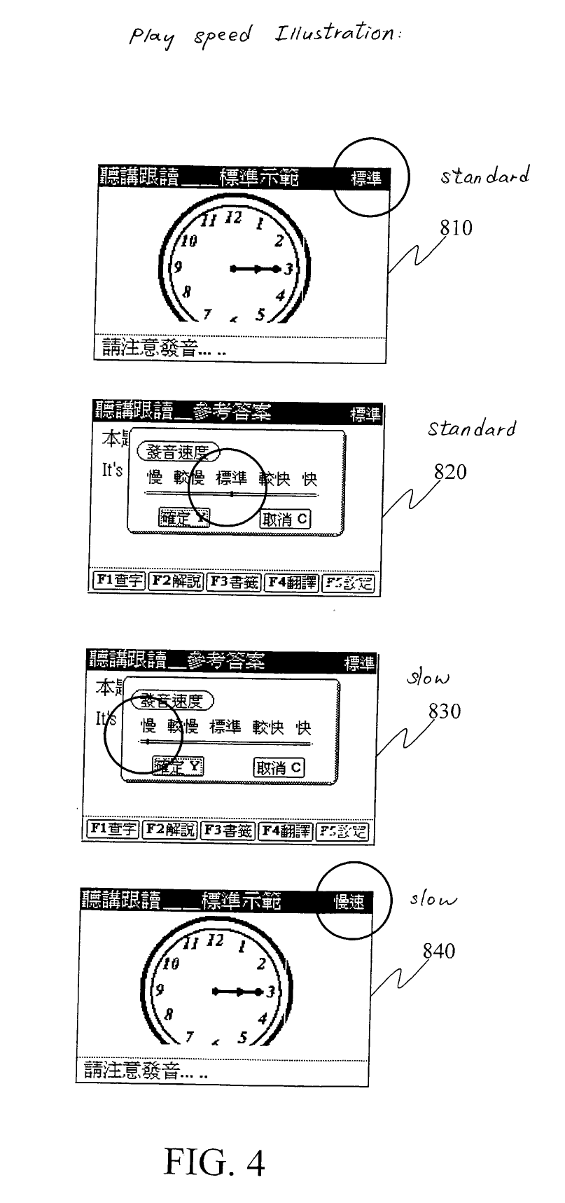

With reference to FIG. 4, we use an embodiment to explain the feasibility of the invention. This embodiment explains the standard demonstrative voice play speed adjustment. The first plot shows the screen of the original standard demonstrative voice playing 810. At this moment, the system uses the default setting values to play (i.e. the “Standard” shown in the black circle). If the user thinks that the system default play speed is too fast, he/she can make changes to the play speed through the UI 100. The system then enters the screen of changing the play speed 820 in the second plot. At this moment, the play speed stays at the system deafult one, i.e. the “Standard” enclosed by a black circle. The user can thus arbitrarily change the play speed settings through the UI 100. (In this embodiment, the speed is changed to “Slow.”) After the settings are completed, the original play speed setting screen 820 changes to the modified one 830 shown in the third plot. One sees that the play speed is “Slow” as indicated by the black circle. Once the setting change is finsihed, the system returns to the standard demonstrative voice playing screen. Please notice that the speed has been changed to “Slow” in the modified standard demonsatrative voice playing screen 840 in the fourth plot. So the system uses the user selected “Slow” speed to play the standard demonstrative voice. By now, the user has completed the dynamical parameter modification process.

### Effects of the Invention

The disclosed conversation practice system with a dynamically adjustable play speed and the method thereof allows the user to make changes to the material play speed according to the user's preference. The user is thus able to learn better in a personalized environment.

In addition, using a computer-aided technology to help learning a foreign language does not only save its user a lot of time in learning, the user does not need to worry about talking to a foreigner face to face. The user can even repeatedly practice listening and speaking anytime anywhere. So the invention provides users a simple and convenient way of learning a foreign language.

Certain variations would be apparent to those skilled in the art, which variations are considered within the spirit and scope of the claimed invention.

What is claimed is:

1. A conversation practice system with a dynamically adjustable play speed in which a user is capable of dynamically performing play speed settings during a follow-reading procedure through a UI (User Interface) and the system immediately makes modification accordingly for the user to complete conversation practice, the system comprising:
a material database, which stores more than one problem sample datum for the user to perform the follow-reading procedure;
a problem module, which selects and extracts one problem sample datum from the material database;
a follow-reading module, which outputs the extracted problem sample datum to the user for continuing the follow-reading procedure; and
a dynamical parameter setting module, which allows the user to perform parameter settings relevant for the play speed during the follow-reading procedure.

2. The system of claim 1, wherein the problem sample datum includes a material sample datum code, a standard demonstrative voice content, and a material sample text content.

3. The system of claim 1, wherein the follow-reading module includes a voice-playing unit for outputting the problem sample datum.

4. The system of claim 1, wherein the dynamical parameter setting module provides the setting and adjustment of the play speed during the follow-reading procedure.

5. A conversation practice method with a dynamically adjustable play speed in which a user is capable of dynamically performing play speed settings during a follow-reading procedure through a UI (User Interface) and the system immediately makes modification accordingly for the user to complete conversation practice, the method comprising the steps of:
starting a conversation practice system and performing initialization of parameter settings;
obtaining a problem sample datum and starting a follow-reading procedure;
the user's performing dynamical parameter settings during the follow-reading procedure;
restarting the follow-reading procedure according to the dynamical parameter setting content; and
the user's completing the whole follow-reading procedure.

6. The method of claim 5, wherein the problem sample datum comprises a material sample datum code, a standard demonstrative voice content, and a material sample text content.

7. The method of claim 5, wherein the dynamical parameter setting module provides the setting and adjustment of the play speed during the follow-reading procedure.

8. The method of claim 5, wherein the step of the user's performing dynamical parameter settings during the follow-reading procedure further comprises the steps of:
composing a problem;
playing the standard demonstrative voice of the problem sample datum;
performing play speed settings;
the user's participating in the follow-reading procedure; and
completing the follow-reading procedure for the problem sample datum.

9. The method of claim 8, wherein the step of performing play speed settings further comprises the method of redoing initialization of parameter settings.
